(19) United States
(12) Patent Application Publication
(10) Pub. No.: US 2025/0065327 A1
(43) Pub. Date: Feb. 27, 2025

(54) Biochip Coupling Systems and Devices

(71) Applicant: Overture Life, Inc., New York, NY (US)

(72) Inventors: Pablo Carasa Ruiz, Madrid (ES); Eduardo Bajo Ortiz, Madrid (ES)

(73) Assignee: Overture Life, Inc., New York, NY (US)

(21) Appl. No.: 18/722,224

(22) PCT Filed: Dec. 21, 2022
(86) PCT No.: PCT/IB2022/062626

§ 371 Date: Jun. 20, 2024

Related U.S. Application Data
(60) Provisional application No. 63/292,812, filed on Dec. 22, 2021.

(30) Foreign Application Priority Data
Mar. 16, 2022 (EP) 22162547.8

(51) Int. Cl. B01L 3/00; B01L 9/00

(52) U.S. Cl. CPC B01L 3/502715; B01L 9/527; B01L 2200/027; B01L 2200/04; B01L 2200/10; B01L 2200/16; B01L 2300/0636; B01L 2300/0819; B01L 2300/087

(57) ABSTRACT

Biochips coupling system and devices refers to biochip coupling devices, biochips, and coupling systems comprising biochip coupling devices and biochips. In some embodiments, a coupling device is integrated with a reusable station that comprises a pneumatic system for which a biochip having at least one microfluidic channel can be inserted therein. In some embodiments, a coupling device can be integrated with other apparatuses with pneumatic systems to which biochips can be coupled. In some embodiments, systems, devices, and biochips described herein are used for biological protocols, for example, vitrification (cryopreservation) and warming (thawing) of embryos. The systems, devices, and biochips described herein can be configured for automated or manual use.

### OBJECT OF THE INVENTION

The present invention refers to biochip coupling devices, biochips, and coupling systems comprising biochip coupling devices and biochips. In some embodiments, a coupling device is integrated with a reusable station that comprises a pneumatic system for which a biochip having at least one microfluidic channel can be inserted therein. In some embodiments, a coupling device can be integrated with other apparatuses with pneumatic systems to which biochips can be coupled. In some embodiments, systems, devices, and biochips described herein are used for biological protocols, for example, vitrification (cryopreservation) and warming (thawing) of embryos. The systems, devices, and biochips described herein can be configured for automated or manual use.

### State of the Art

Microfluidic biochip devices are important tools in clinical diagnostics and assisted reproductive technologies (ART). For example, microfluidics can be useful for human in vitro fertilization (IVF), embryo culture and analysis, and embryo cryopreservation processes. Cryopreservation is necessary for long-term storage of oocytes or embryos obtained from patients in clinical assisted reproduction laboratories, for later use as part of an assisted reproduction treatment. Cryopreservation methods, such as slow freezing or vitrification, involve the use of cryoprotectants to reduce damage by ice crystal formation in the cytoplasm of oocytes or cells of the developing embryo.

### DESCRIPTION

In some aspects, the present disclosure provides a coupling device for coupling a biochip to a pneumatic system, the device comprising:
a) a pressurization core that is pneumatically connected to the pneumatic system, wherein the pressurization core is configured to receive the biochip and provide a pressurized seal between the biochip and the pneumatic system when the biochip is coupled to the pressurization core;
b) a blocking mechanism coupled to the pressurization core, wherein the blocking mechanism is configured to anchor the biochip to the pressurization core at a position suitable for providing the pressurized seal; and
c) a guiding platform coupled to the pressurization core, wherein the guiding platform is configured to guide the pressurization core and the biochip to slide along the guiding platform to a position at which the blocking mechanism anchors the biochip to the pressurization core.

In some aspects, the present disclosure provides a system, the system comprising:
a) a coupling device, wherein the coupling device comprises:
   i) a pressurization core that is pneumatically connected to the pneumatic system, wherein the pressurization core is configured to receive the biochip and provide a pressurized seal between the biochip and the pneumatic system when the biochip is coupled to the pressurization core;
   ii) a blocking mechanism coupled to the pressurization core, wherein the blocking mechanism is configured to anchor the biochip to the pressurization core at a position suitable for providing the pressurized seal; and
   iii) a guiding platform coupled to the pressurization core, wherein the guiding platform is configured to guide the pressurization core and the biochip to slide along the guiding platform to a position at which the blocking mechanism anchors the biochip to the pressurization core; and
b) a station, wherein the station is configured to receive the device.

In some aspects, the present disclosure provides a biochip, the biochip comprising:
a) a body comprising a surface;
b) a microfluidic channel,
c) a pathway on the surface of the body, wherein the pathway comprises at least two curves;
d) an orifice connected to a reservoir that is fluidically connected to the microfluidic channel, wherein the orifice is at a base of a cavity in the body of the biochip; and
e) a sealing gasket, wherein the sealing gasket is located in the cavity of the body of the biochip, wherein the sealing gasket comprises a through hole configured to be aligned with the orifice in the biochip.

In some aspects, the present disclosure provides a coupling system, the coupling system comprising:
a) a biochip, wherein the biochip comprises:
   i) a body comprising a surface;
   ii) a microfluidic channel,
   iii) a pathway on the surface of the body, wherein the pathway comprises at least two curves;
   iv) an orifice connected to a reservoir that is fluidically connected to the microfluidic channel, wherein the orifice is at a base of a cavity in the body of the biochip; and
   v) a sealing gasket, wherein the sealing gasket is located in the cavity, wherein the sealing gasket comprises a through hole configured to be aligned with the orifice in the biochip;
b) a pneumatic system configured to deliver pressurized air to the biochip; and
c) a coupling device for coupling the biochip to the pneumatic system, wherein the coupling device comprises:
   i) a pressurization core that is pneumatically connected to the pneumatic system, wherein the pressurization core is configured to receive the biochip and provide a pressurized seal between the biochip and the pneumatic system when the biochip is coupled to the pressurization core;
   ii) a blocking mechanism coupled to the pressurization core, wherein the blocking mechanism is configured to anchor the biochip to the pressurization core at a position suitable for providing the pressurized seal; and
   iii) a guiding platform coupled to the pressurization core, wherein the guiding platform is configured to guide the pressurization core and the biochip to slide along the guiding platform to a position at which the blocking mechanism anchors the biochip to the pressurization core.

In some aspects, provided herein is a coupling device for coupling a biochip having one or more microfluidic channels to a pneumatic system, the coupling device comprising:
a guiding platform;
a pressurization core for receiving the biochip, wherein the biochip is slidable over the pressurization core, and the pressurization core is slidable over the guiding platform; and
a blocking mechanism for anchoring the biochip to the pressurization core.

The coupling device can comprise a base or guiding platform configured to guide a pressurization core over the base or guiding platform. The pressurization core can comprise a wall with a front side and a back side. The front side and back side can be connected through at least one passing hole. The front side can comprise at least one first nozzle connection to be coupled to a pneumatic system and at least one compression spring disposed between the wall of the pressurization core and a holder on the guiding platform. The spring can be configured to exert a force between the biochip and the pneumatic system.

The back side, opposite the front side of the wall, can comprise at least one nozzle fitting connected to the at least one nozzle through the at least one through hole, where the nozzle fitting is configured to connect the pressurization core to the pneumatic system.

The coupling device can further comprise a blocking mechanism for receiving and anchoring to the biochip. The blocking mechanism can be disposed over the pressurization core and connected to the guiding platform. The blocking mechanism of the coupling device can comprise a cam follower having a tip that interacts with a pathway on a surface of the body of the biochip. The cam follower can be configured to travel along the pathway on the biochip to anchor the biochip to the pressurization core. The pathway, depending on the presence of one or more cam followers, can be disposed on a top surface of the body of the biochip. In some embodiments, the pathway can be disposed on one or more lateral surfaces of the body of the biochip.

As such, the biochip can comprise a body and at least one microfluidic channel wherein a surface of the body of the biochip has at least one pathway. The pathway can comprise at least two curves. The pathway can be configured to receive a cam follower of the blocking mechanism in the pressurization core. Additionally, the biochip can comprise at least one orifice connected to at least one reservoir of the biochip. The orifice can be disposed at the base of a cavity in the body of the biochip. A sealing gasket disposed in the cavity, wherein the gasket comprises at least one through hole aligned with the orifice in the biochip.

The biochip can also include:
a microfluidic layer having microfluidic features, e.g., one or more microfluidic channels and a well etched or imprinted therein, wherein the microfluidic layer provides a connection between external reservoirs fluidically connected to the microfluidic layer and the well. Different types of microfluidic layers can be used.
a reservoir layer or body disposed on the upper surface of the microfluidic layer. The reservoir layer can comprise three independent chambers or reservoirs for containing two reagent media and the waste media, respectively. The reservoir layer further comprises orifices connecting to the chambers for connecting to a pneumatic system, thereby allowing air passage into the chambers. The reservoir layer can further comprise two caps in the chambers for sealing the reservoirs. The caps can be opened and closed by pressure, a screwing mechanism, or auto-sealing. The reservoir layer can also comprise the peripheral walls of the well in the microfluidic layer. The back surface of the reservoir layer can further comprise three small entrances or orifices corresponding to the pressurization points with a sealing gasket. The back surface of the reservoir layer can further comprise through holes disposed above the orifices in the reservoir layer, and interface with the coupling device. Further, the reservoir layer can comprise lateral guides on the sides of the reservoir layer, as well as on the top surface. The lateral guides can be used for guiding the reservoir layer and the biochip during coupling. The opposite side to the back surface can comprise a superior wall of the well.
The biochip can have different configurations in respect to the microfluidic channels and reservoirs, for example:
i) The biochip has at least one reservoir with at least two pressure inlets, for example a positive pressure inlet and a negative pressure inlet (outlet), and/or
ii) The biochip has at least one reservoir with one pressure inlet, for a positive or negative pressure inlet/outlet, and/or
iii) The biochip has at least one microfluidic channel connected to at least two reservoirs, and/or
iv) The biochip has at least two microfluidic channels connected to at least the same reservoir, and/or
v) The biochip has at least one microfluidic channel connected to one reservoir,
a lid layer, wherein the lid layer is configured to cover and seal the microfluidic channels on the lower surface of the microfluidic layer at the bottom of the biochip.

A coupling system can be formed by joining a biochip and a coupling device. As described above, the coupling device can comprise a pressurization core and a guiding platform on which the pressurization core slides. In some embodiments, the pressurization core is a pressurization compartment. The coupling device can also comprise a blocking mechanism for anchoring the biochip to the pressurization core. As such, the coupling system can comprise:
the orifice connected to a chamber or reservoir of the biochip facing the nozzle fitting on the back side of the wall of the coupling device;
the cam follower of the coupling device introduced in the pathway of the body of the biochip, wherein the pathway provides a static or blocking position between the biochip and the coupling device; and
the sealing gasket of the biochip, disposed between the nozzle fitting of the coupling device and the orifice on the biochip, comprising a through hole connecting the nozzle fitting and the orifice.

The system comprising the coupling device and the biochip can further comprise sensors for determining the relative position of the biochip with respect to the coupling device. The sensors can inform a user about the position of the biochip relative to the coupling system. For example, the sensors can indicate whether the biochip is properly coupled to in the coupling device. Thus, the sensors can reduce the likelihood of improper use of the coupling system during a protocol.

According to the features described above, the coupling device can allow:
mechanical pressurization between the biochip and the coupling device using compression springs that apply force to ensure proper sealing between the biochip and a pneumatic system to reduce the likelihood of air leaks. Proper sealing can be achieved by a hermetic seal provided by the sealing gasket, pressure connectors, and nozzles on the coupling device against an elastomeric material on the biochip. The seal provides an air-tight seal against the gasket surrounding three air inlets of the biochip; and/or
coupling of the biochip and the coupling device through a push-push mechanism that allows for both anchoring of the biochip to the coupling device during coupling and removal of the biochip from the coupling device during de-coupling. This push-push mechanism can be achieved by use of a torsion spring attached to a cam follower pin that follows a pathway imprinted on the biochip. The cam follower can pass through three positions on the biochip. This mechanism anchors the biochip to the coupling device and ensures a tightly sealed coupling of the biochip with the coupling device; and/or
use of optical sensors on a PCB. The PCB can be disposed underneath the pressurization core and/or below the guiding platform. Further, a side of the pressurization core can comprise two flanges. The PCB can comprise two sensors. Each of the two sensors can be configured to detect one of the flanges of the pressurization core when the pressurization core is disposed on the guiding platform at a position to form the pressurized seal between the biochip and the pneumatic system. The sensors can be configured to detect and provide feedback to a user regarding positioning of the biochip, e.g., according to the three positions of the cam in the biochip. These sensors can indicate to the user whether the biochip is properly positioned. For example, if the positioning is detected as improper, then the system will not allow a protocol to be executed on the biochip to commerce. For this purpose, the pressurization core can comprise two flanges detectable by two sensors connected to the main PCB for determining the position of the pressurization core with respect to the guiding platform.

The coupling device can be integrated with a reusable station for receiving the biochip. The station can further comprise a body including a pneumatic system, an energy module, a display module, a casing for encasing all the components in the station, and a housing with the pressurization core for receiving a biochip.

### BRIEF DESCRIPTION OF THE FIGURES

FIG. 1, Panel A shows a biochip and a station in which the biochip can be inserted. Panel B shows an exploded view of a biochip showing components thereof.

FIG. 2 shows a biochip and components thereof.

FIG. 3 shows the back side of a biochip showing the pressurization points.

FIG. 4 shows a top view of a biochip.

FIG. 5 shows a back perspective view of the biochip showing a sealing gasket.

FIG. 6 shows a back view of a biochip with a hydrophobic membrane and a sealing gasket.

FIG. 7 shows a perspective view of a coupling device with the pressurization system.

FIG. 8 shows a front perspective view of the pressurization core of the coupling device.

FIG. 9 shows a top view of the pressurization core of the coupling device.

FIG. 10 shows a front perspective view of the pressurization core of a coupling device including the nozzles.

FIG. 11 shows a perspective view of a coupling device.

FIG. 12 shows a detailed sectional view of the coupling between a coupling device and a pneumatic tube of a pneumatic system coupled to the nozzle.

FIG. 13 shows a perspective view of a pressurization core that slides on a base or guiding platform.

FIG. 14 shows a blocking mechanism of a coupling device.

FIG. 15 shows a detailed view of the blocking mechanism showing a cam follower.

FIG. 16 shows a top view of the blocking mechanism with potential pathways of the cam follower.

FIG. 17 shows a perspective detailed view of the blocking mechanism of the coupling device interacting with the biochip and an amplification of the interaction between the tip of the cam of the blocking mechanism and the pathway on the biochip.

FIG. 18 shows a perspective view of a biochip coupled to a pressurization core of a coupling device.

FIG. 19 shows a perspective view of a biochip coupled to a pressurization core and blocking mechanism of a coupling device.

FIG. 20 shows a sectional view of a biochip coupled to a pressurization core and blocking mechanism of a coupling device.

FIG. 21 shows a top view of a biochip with a W-shaped pathway, and a zoomed area of the pathway where three positions of the biochip in the coupling device are identified: a first limit position, a second blocked position, and a third released position.

FIG. 22 shows a pressurization core of a coupling device interacting with the sensors on a printed circuit board (PCB).

FIG. 23 shows a pressurization core of a coupling device in a blocked position, interacting with the sensors on the PCB.

FIG. 24 shows a pressurization core of a coupling device in a limit position, interacting with the sensors on the PCB.

FIG. 25 shows a pressurization core of a coupling device in a released position, interacting with the sensors on the PCB.

FIG. 26 shows a biochip coupling device with screw reservoir caps.

FIG. 27 shows a biochip coupling device with screw reservoir caps and a station in which the biochip coupling device is inserted.

### PREFERRED EMBODIMENTS

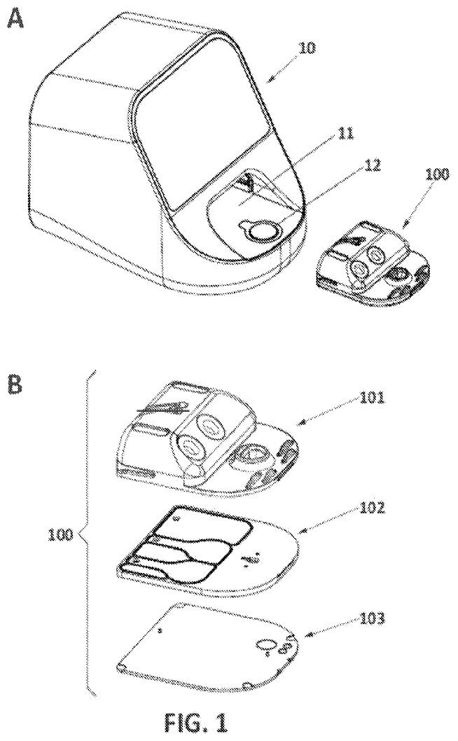

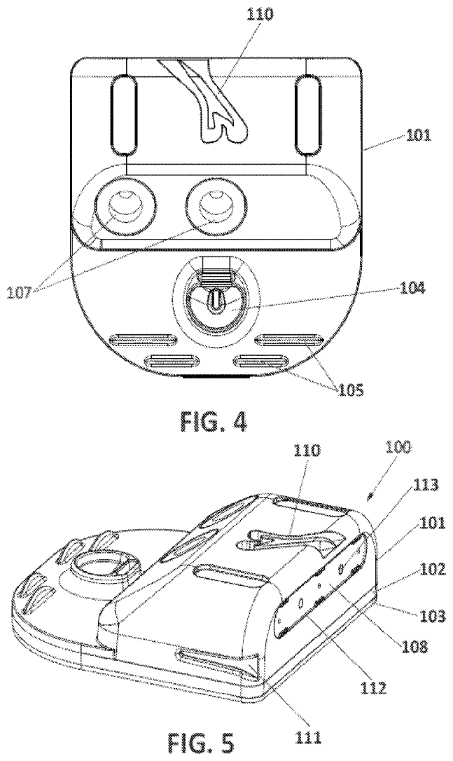

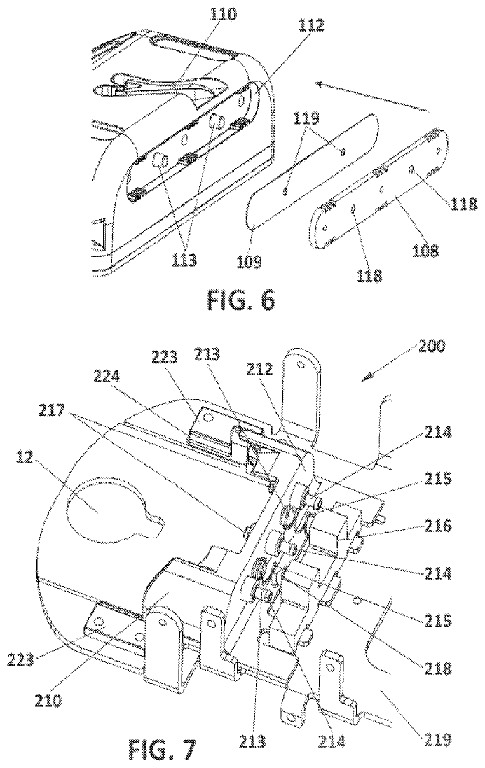

As shown in FIG. 1-7, provided herein is a coupling device (200) for coupling a biochip (100) having microfluidic channels to a reusable station (10). The coupling device (200) comprising the biochip (100) can be received by a reusable station (10) via housing (11) as shown in FIG. 1, Panel A. The station (10) serves as a user interface for actuating processes on the biochip (100). For example, the station (10) can be used to run a protocol to be executed in the biochip (100). The biochip (100) holds biological sample(s), as well as the reagents that interact with the biological sample(s). In some embodiments, the station (10) contains an electronic circuit board, e.g., a printed circuit board (PCB) for controlling interactions between the samples and the reagents. The biochip can be disposable or reusable.

The coupling device (200) can comprise a pressurization core (210) that slides on a guiding platform (219). Both the pressurization core (210) and the guiding platform (219) are disposed within the station. FIG. 18 shows a perspective view of a biochip (100) coupled to a pressurization core (210) of a coupling device. The coupling device (200) can also comprise a blocking mechanism (300) for mediating the coupling between the biochip (100) and the coupling device (200) as shown in FIG. 14.

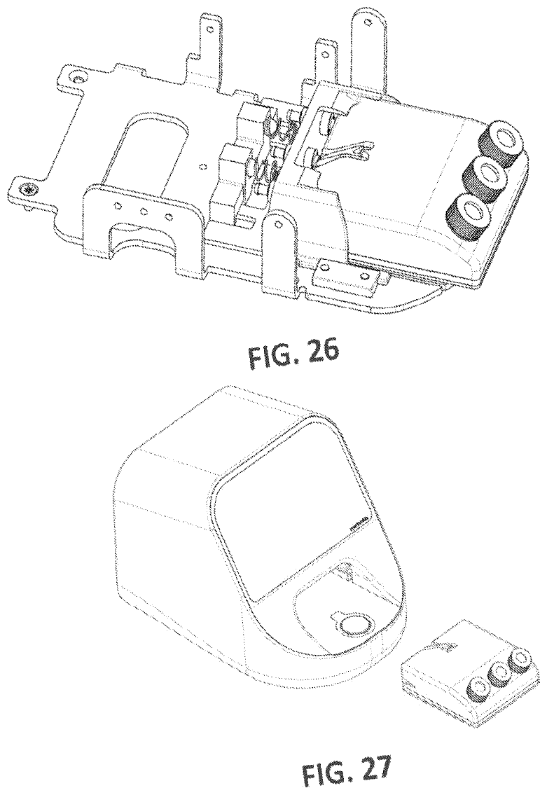

The biochip (100) can comprise different biocompatible, e.g., polymeric, parts bonded together. As shown in FIG. 1-5, the biochip can comprise:
a microfluidic layer (102), where microfluidic features, e.g., one or more channel and a well (104) are etched. The microfluidic layer provides fluid connection between the reservoirs or chambers (106), where the reagents are stored, and the well. In some embodiments, the microfluidic layer can further comprise a mechanism (105) for coupling the biochip to an external device, e.g., a cryostorage device.
a reservoir layer (101), disposed on the upper surface of the microfluidic layer (102). In some embodiments, the reservoir layer comprises three independent chambers (106) acting as reservoirs for containing two reagent media and waste media. The chambers (106) for the reagents can be closed or sealed with caps (107). For example, the chambers can be sealed with screw caps that can be opened to allow a user to fill the chambers with the reagents (FIGS. 26 and 27). The reservoir layer (101) can comprise a pressure interface that interacts with the coupling device of the station (100). The reservoir layer also comprises the peripheral walls of the well (104) in the microfluidic layer.
a lid layer (103) for covering and sealing the microfluidic channels on the lower surface of the microfluidic layer (102) that is the bottom surface of the biochip (10).

The microfluidic layer (102) of the biochip can comprise:
Two or more inlets, serving as fluidic entrances from the chambers (106) with reagents to the channels.
An outlet, serving as fluidic outlet from the waste channel to the waste reservoir.
Reagent channels or microfluidic ducts connected to the two inlets, designed to exhibit hydrodynamic resistance based on geometry and size of the channels.
A waste channel, which is a microfluidic duct connecting the well to the outlet.
A mixing channel in which the media from the two or more inlets mix together and travel to the well.
A well, where the biological sample is loaded and contained, and the media exchange of the biological sample can occur.

In the microfluidic layer (102), the channels create a microfluidic structure that allows the control of the system based on adjustable pressures and flow rates.

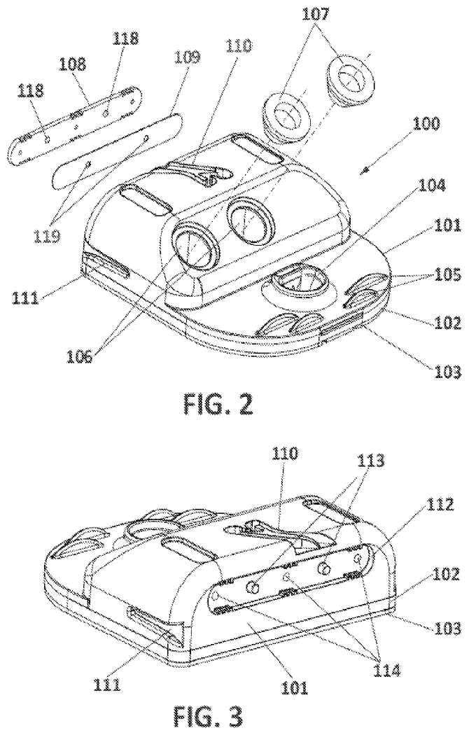

As shown in FIG. 2, fluid media can travel through a hole from the chamber (106) in the reservoir to an inlet of the channel on the bottom side of the microfluidic layer (102). This movement of the media can be actuated by pressurization of the chambers (106). For each reagent, there is an independent inlet in the layer (102) connected to the chambers (106).

After the assembly of the full biochip (100), the outlet remains connected to the waste chamber (not shown) of the reservoirs. In this case, the fluid flows in an opposite direction from the reagents (i.e., from the chamber to the channel), traveling from the channels to the waste chamber, where the waste fluid is stored until the protocol finishes and the full biochip (100) can be removed or discarded.

The reagent channels can be designed to exhibit hydrodynamic resistance based on a specific geometry, size, and length of the channel for each inlet. Hydrodynamic resistance in the microfluidic channels provide the proper flow rates based on a certain pressure, while taking into account fluidic properties of each media. Reagent channels and the outlet channels can vary on the length and section. The channels can be serpentine shaped. This geometry can maximize fluid capacity of the channels, as well as increase the hydraulic resistance within the channels.

The mixing channel connects the two inlet reagent channels and the well. The mixing channel can enhance the contact between the two or more reagents media, thereby improving the mixing of the reagents before reaching the entrance of the well. Each curve of the serpentine pathway of the channel enhances the mixing of the two reagents.

The well (104) is a main part of the biochip (100), where the sample can be loaded and contained, and the media exchange of the sample can occur due to media flow from the inlet reagent channels and flowing out through the outlet channel. The well can be formed by the bonding between the reservoir layer (101) and the microfluidic layer.

As shown in FIG. 1-4, the reservoir layer (101) or body contains the chambers (106) in which the reagents media and the waste media are stored. The reservoir layer comprises a pressure interface with the coupling device of the station (10), two caps (107) for the user to fill the chamber (106) with the reagents, and an extrusion that is the top part of the well (104). This reservoir layer (101) can be bonded on the top of the microfluidic layer (102). The reservoir layer (101) can include one or more of the following components: chambers (106), caps (107), a sealing gasket (108), and an hydrophobic membrane (109). The sealing gasket (108) and the hydrophobic membrane (109) can be located in a cavity (112) in the back surface of the reservoir layer (101) of the biochip (100). The cavity (112) comprises at least two pins (113) where corresponding orifices (118) in the gasket (108) and orifices (119) in the membrane (109) fit.

The reservoir layer (101) can comprise three chambers (106). Two chambers can store the reagents media and can be accessible by the user from the top through two openings where the caps (107) are disposed. The third chamber can store waste media and can be filled as the media travels through the well, e.g., during execution of a protocol. In some embodiments, the waste chamber has no access to other chambers or channels of the biochip. As shown in FIG. 3, the back surface of the biochip (100) has three entrances (114) corresponding to the pressurization points that interface with the coupling device (200). Further, the station comprises lateral guides (111) on the sides of the body and a top pathway (110) on the top surface that can be used to receive the biochip (100) and to couple the biochip (100) to the coupling device (200) in the station (10). As shown in FIG. 2, the front surface, opposite to the back surface, comprises the superior wall of the well (104). The superior wall can be continuous in shape with the functional well in the microfluidic layer (102) of the biochip (100).

The reservoir caps (107) are disposed on each opening of the two chambers (106) that contain reagent media. The caps promote sealing of the chamber entrances after filling of the chambers (106) with media. In some embodiments, the caps are smart caps comprising a push-in, one-way elastomeric valve with a dome shape and a slit on the tip of the dome as depicted in FIG. 2. The elastomeric material of the caps allows the slit to open when a pipette tip enters and self-closes once the pipette tip is removed.

Additionally, when positive pressure is applied to the reservoirs, the dome shape of the bottom of the caps helps to seal the caps evenly. The self-sealing caps further allow a user to fill the chamber (106) rapidly and efficiently, e.g., using only one hand, thereby improving the ergonomics of the biochip (100) and streamlining workflow. Alternatively, other caps can be used, for example, removeable caps. Removable caps can be removed during filing of the reservoirs and then replaced to seal reservoirs. Removeable caps can be closed and open by pressure or by screwing, e.g., removeable screw caps. As shown in FIGS. 2 and 5, the gasket seal (108) seals the pressure interface between the coupling device (200) and the chamber (106), specifically at the nozzles (217) on the pressurization core (210) of the coupling device (200) as depicted in FIGS. 7, 9, and 10. The gasket (108) comprises three holes (104), each aligned with the pressurization entrances of the chamber (106). This sealing gasket (108) can be a flexible element, e.g., made from silicone, to ensure a leak-proof seal that adapts to the nozzle shape.

As shown in FIG. 2, the hydrophobic membrane (109) is a flat sheet membrane that is die cut into a specific shape to fit the pressurization area. This membrane (109) can be disposed between the reservoir layer (101) in the biochip (100) and the gasket (108), thereby keeping the gasket in place. The hydrophobic membrane can reduce the likelihood of cross contamination, for example, by:
Filtering the pressurized air originating from the station (100) to the reservoirs (106). The hydrophobic membrane can reduce the likelihood of any impurities from entering the chambers (106) and contaminating the media; and
Reducing the likelihood of leakage of media from the reservoirs (106) from entering the pneumatic system through the pressure openings due to its hydrophobic properties.

As shown in FIG. 1-3, the lid layer (103) can be a polymeric layer that covers and seals the microfluidic channels in the microfluidic layer (102) at the bottom, and seals the biochip (100) at the lower surface. The lid layer can have the same shape as the lower surface of the microfluidic layer (102), such that the lid layer covers the channels and creates an even, flat surface on the bottom of the disposable biochip (100).

In some embodiments, the biochip (100) can have one of more the following features:
disposability, single use;
transparency;
a well and reservoirs having shapes and sizes compatible with pipettes and other tools used by embryology;
a well accessible by a user for loading a sample, but not removable during execution of a protocol;
parts made from biocompatible materials, particularly parts of the biochip that for safe contact with biological materials, e.g., cells or biological fluids;
parts manufactured by injection molding, particularly parts of the biochip that may be in contact with biological materials, e.g., cells or biological fluids;
a leak-proof interface between the microfluidic layer and the lid layer;
a leak-proof interface between the microfluidic layer and reservoir layer;
absence of cytotoxic materials;
a configuration that allows recovery of biological material during an automated protocol, e.g., in case of malfunction, to allow manual processing of a protocol;
identifiable reservoirs, e.g., identifiable by different colors or labeling for different media; and
a waste reservoir with limited accessibility such that fluid can flow into the waste reservoir, but fluid cannot flow out from the waste reservoir into other areas of the biochip.

The coupling device (200) can be used to promote proper coupling between a biochip and a pneumatic system, e.g., a pneumatic system housed in a station (10). The coupling device (200) can comprise a pressurization core (210) and a blocking mechanism (300) that serves as a mechanical interface between the pneumatic system in the station (10) and the biochip (100). The coupling device (200) can be disposed within a station (10) in which the biochip (100) is inserted. The station (10) can comprise a body having a main electronic PCB (410), a pneumatic system (not shown), the coupling device (200) comprising the pressurization core (210) and optionally, one or more of: the blocking mechanism (300), an energy module, a display module, a casing for encasing all the components in the station (10), and a housing (11) for receiving the biochip (100).

The pneumatic system can comprise the pumps, valves, and tubes (30) that provide and modulate air pressure in the reservoirs (106) and channels of the biochip (100). The energy module can supply the station with sufficient power for the system to operate independently and wirelessly. The display module can be the main interface between the user and the station, i.e., the display module provides a user interface for a user to control the system and/or device. The station can also comprise a heating system (12) for heating different parts of the biochip, e.g., the well as depicted in FIG. 1, Panel A.

As such, the coupling device (200) serves as the interface between the pneumatic system in the station (10) and the biochip (100). This sealed, leak-proof interface provides a closed system to allow pressurization of the channels in the biochip (100). The pressurization core (200) of the coupling device that is in contact with the biochip (100) can be configured to slide over a base or guiding platform (219). The pressurization core (210) in the coupling device (200) can be preloaded by compression springs (215) to ensure that the pressurization nozzles (217) of the pneumatic system apply a force to the sealing gasket (108) of the biochip (100). As such, the assembly can allow pressurization of the biochip via the pneumatic system.

As shown in FIG. 7, the coupling device (200) can comprise one or more of the following features:
A pressurization core (210) serving as an interface between the biochip (100) and the pneumatic system, e.g., in a station (10).
Nozzles (217), which are parts of the pressurization core (210) and carry air pressure from the pneumatic tubes (30) of the pneumatic system to the reservoirs (106) of the biochip (100);
A holder (216) on a guiding platform (219) for anchoring the pressurization core (210). The holder provides stability during coupling. As a fixed component of the system, the holder guides the movement of the core (210) by transmitting force of the springs (203) to the core (210); and
Springs (215) for transmitting the compression force to reduce the likelihood of leaks between the device (200) and the sealing gasket (108) of the biochip (100).

The pressurization core (210) is the main part of the coupling device (200). The pressurization core is a sliding component that receives the biochip (100) and transfers the force from the compression springs (215) in the device (200) to the pressurization nozzles (217). In some embodiments, the system comprises three pressurization nozzles (217) that connect to three pressurization points (114) for each of the three reservoirs (106) in the biochip (100). The nozzles (217) carry air pressure from the pneumatic system to the biochip (100) reservoirs (106). These nozzles (217) can be threaded to a vertical wall (212) of the pressurization core (210). On one side, the front side, the nozzles are in contact with the gasket (108) of the reservoir layer (101) in the biochip (100). In this manner, the nozzles can apply force applied by the compression springs (215) to promote leak-proof sealing between the biochip (100) and the pressurization core (210) of the coupling device (200). On the other side, the back side, the nozzles can comprise barbed fittings (214) that facilitate leak-proof connection with the tubes (30) of the pneumatic system.

As shown in FIG. 7-9, the pressurization core (210) of the coupling device (200) can have a vertical wall (212) with three through holes (211) that are configured to receive the nozzles (217); and two protrusions (213) on a back side of the wall (212) of the core (210), located between the holes (211) or nozzles (217), for fixing the springs (215). A horizontal base (221) of the core (210) can comprise four slots (222) that limit excessive rotation of the horizontal base and act as stoppers for the sliding movement of the core (210).

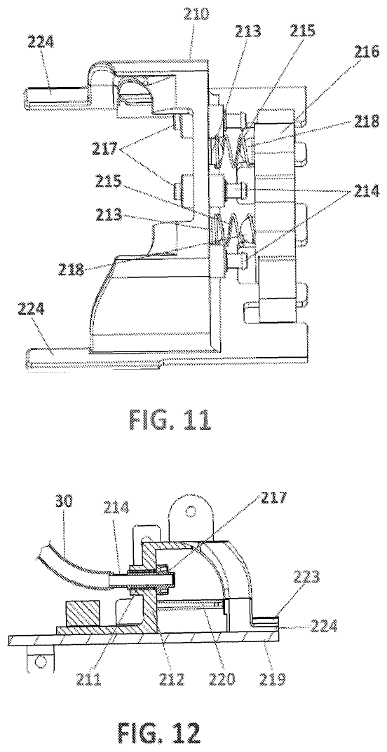

On the back side of the device (200), the holder (216), located on the guiding platform (219), is configured to hold the compression springs (215), which can be disposed between protrusions (218) in the holder (216) and the protrusions (213) on the back side of the vertical wall (212) of the core (210). The holder (216) can also serve as guide or sliding path for the pressurization core (210) during coupling. As shown in FIG. 11, the guiding function of the holder can be achieved by interaction of the holder with the four slots (222) in the base (221) of the core (210).

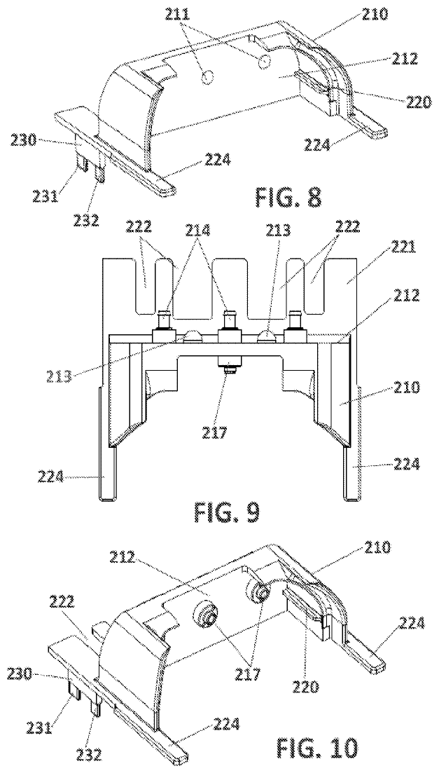

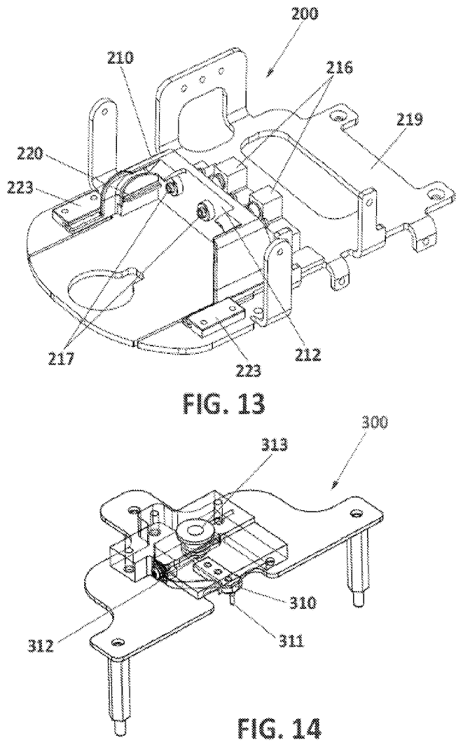

The pressurization core (210) can further comprise a pair of lateral core guides (223), which allow the core to slide over the guiding platform (219). Each of the lateral core guides can be disposed in parallel to one another on the top surface of the guiding platform. Each lateral core guide can comprise a top surface and a bottom surface. The bottom surface of each lateral core guide can be layered onto the top surface of the guiding platform. The top surface of each lateral core guide can comprise an overhanging lip such that the top surface of each lateral core guide has a greater width than does the bottom surface of each lateral core guide. The pair of lateral core guides can be configured to anchor the pressurization core to the guiding platform, reduce a likelihood of rotation of the pressurization core, and guide alignment of the pressurization core and the guiding platform. In some embodiments, the core guides (223) are L-shaped, and are joined to the base or guiding platform (219) such that a pair of lateral legs (224) in the core (210) can slide between the core guides (223) as depicted in FIG. 8-13. The core guides (223) can be partially disposed over the pair of lateral legs (224). Each lateral leg can be disposed in parallel to one another and be configured such that when the pressurization core is disposed on the guiding platform, the pair of lateral legs is parallel to the pair of lateral core guides and each lateral leg fits under the overhanging lip of one of the lateral core guides. The core guides (223) can reduce the likelihood of the vertical plane of the pressurization core (210) from rotating and misaligning with the guiding platform (219). The core guides (223) also keep the core close to the guiding platform (219).

The core (210) can also provide a holding structure for maintaining proper positioning of the biochip (100) during a protocol. For this purpose, the core can have two symmetric elongated extrusions (220) on the inner face of the core (210). The symmetric elongated extrusions (220) fit with the lateral guides (111) of the reservoir layer (101) of the biochip (100).

In some embodiments, one lateral side of the core (210) comprises an asymmetric extrusion (230) with two flanges (231, 232) that are configured to be in contact with two sensors (400) on a main PCB (410) as depicted in FIGS. 8 and 22. Contact between the flanges and the sensor allow determination of the position of the core (210) and the position of the biochip (100) with respect to the coupling device (200) and with respect to the station (10) in which the biochip is received.

The coupling device (200) can comprise a blocking mechanism (300) to affix the biochip (100) in the pressurization position when coupled to the coupling device (200), thereby allowing release of the biochip (100) by a simple interaction by the user. The blocking mechanism (300) can be disposed over the pressurization core (210) and connected to the guiding platform (219) as depicted in FIG. 19.

This blocking mechanism (300) can comprise a cam follower (310) that moves along the pathway (110) on the top surface of the biochip (100), thereby serving as a locking hook for the biochip (100). The top pathway (110) can be a channel or guide having a W-shaped, serpentine pathway having three curves.

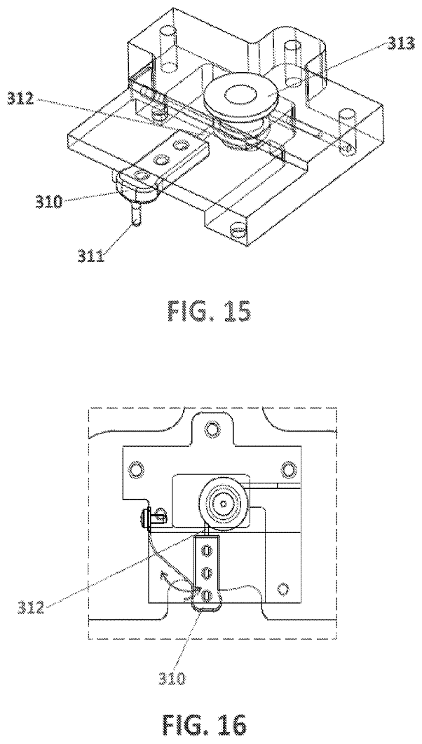

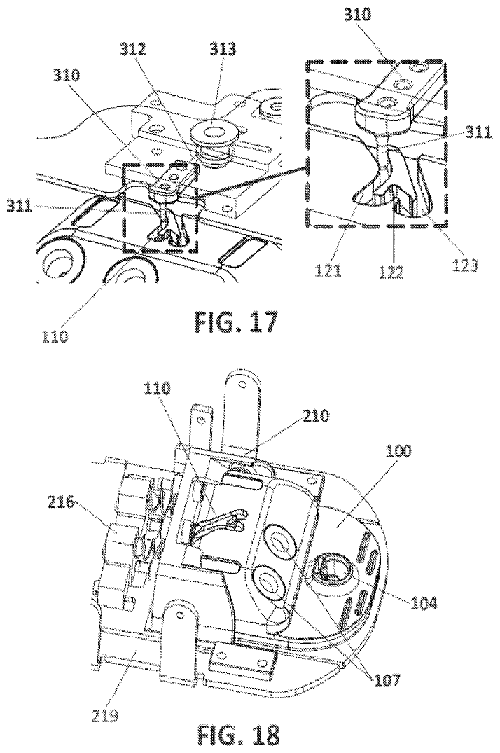

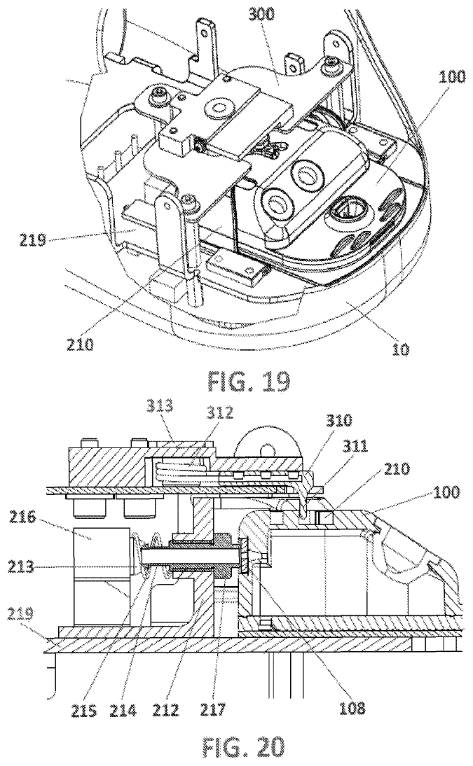

As shown in FIG. 14-20, the cam follower (310) comprises a cylindrical extrusion or tip (311) on one side. The tip (311) can be configured to slide through the top pathway (110) of the reservoir layer (101) in the biochip (100). This cam follower (310) can be attached to a torsion spring (312) through the side that is opposite from where the tip (311) is disposed in the cam follower (310) and has limited vertical movement. The torsion spring (312) guides the movement of the cam follower (310) and returns the cam follower to the initial position after the cam follower is released. This force, in combination with the top pathway (110) profile of the reservoir layer (101), allows the blocking and release of the biochip (100) in the coupling device (200).

The coupling interaction between the biochip (100) and the coupling device (200) can require interaction between the pressurization core (210) and cam follower (310) in the coupling device (210) with the reservoir layer (101) in the biochip (100).

As previously described, to ensure proper coupling between the device (100) and the biochip (100), the coupling device (200) comprises position sensors (400), e.g., two optical sensors on the PCB (410) that inform the user of the biochip (100) position in the coupling device (200). These sensors (400) can interact with the extrusion (230) on the lateral side of the pressurization core (210). Each of the flanges (231, 232) can interact with each of the sensors (400) on the PCB (410) to determine the position of the device (200) and the position of the biochip (100).

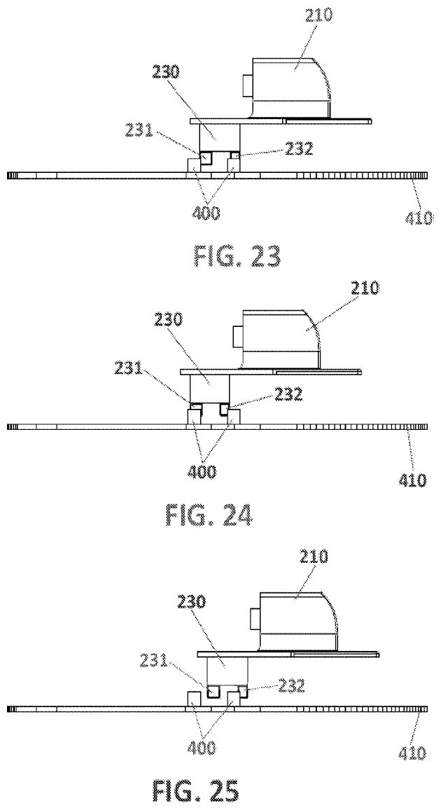

In some embodiments, there are three possible positions of the biochip (100) in the coupling device (200):
Limit position: This position is reached when the user pushes the biochip (100) to the end. At this position, a first “click” sound can be actuated and the cam follower tip (311) reaches the first curve (121) of the W-shaped top pathway (110). In this scenario, the optical sensor (400) on the left is activated (see FIG. 24).
Blocked or pressurization position: This position can be considered as the functioning position for the pressurization in which the pressurization core (210) and the biochip (100) are in pressurized contact. The cam follower tip (211) reaches the second curve (122) of the W-shaped pathway. At this position, the optical sensor (400) on the right is activated (FIG. 23).
Released position: In this position, the biochip (100) can be retrieved from the coupling device (200). The cam follower tip is in the third curve (123) of the W-shaped pathway (110). At this position, none of the optical sensors are activated (FIG. 25).

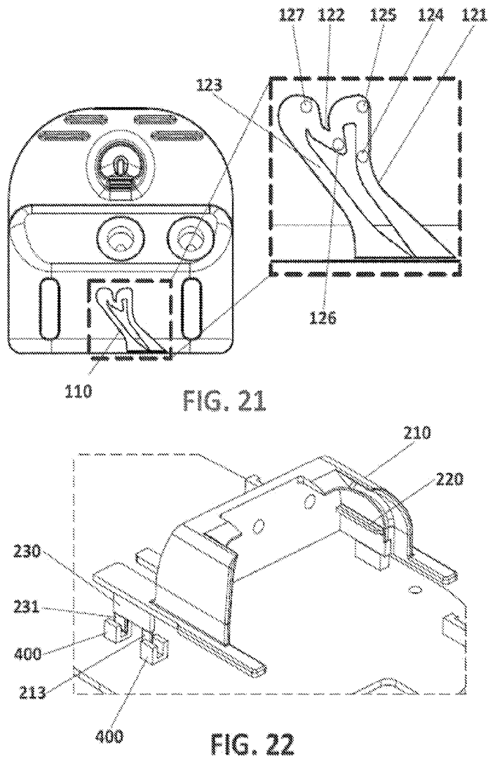

FIG. 21 shows a top view of a biochip with a W-shaped pathway (110), and a zoomed area of the pathway where three positions of the biochip in the coupling device are identified: a first limit position (127 or 125), a second blocked position (126), and a third released position (124). As such, the user actions can include:
For inserting the biochip: The user pushes the biochip (100) to the limit position (127). Thereafter, the compression springs (215) moves the biochip back into the blocked or pressurization position (126) as described above.
For releasing the biochip: After using the biochip (100) coupled to the station (10) through the coupling device (200), e.g., after a vitrification or warming protocol is complete, the user pushes the biochip (100) again to the limit position (125). Thereafter, the compression springs (215) push the biochip back into the released position (124). At this position, the user can remove the biochip (100) from the coupling device (200) and from the station (10).

For each user action described above, there can be a sequence of two different readings of the sensors. With this sensor control, the coupling device can detect whether there is an improper interaction, i.e., improper coupling between the coupling device and the biochip.

In view of the above description, different exemplary embodiments are hereby described:

Embodiment A1. A coupling device (200) for coupling a biochip (100) to a pneumatic system, comprising:
A guiding platform (219);
A pressurization core (210) for receiving the biochip (100), and slidable over the guiding platform (219); and
A blocking mechanism (300) for anchoring the biochip (100) to the pressurization core (210).

Embodiment A2. The device of embodiment 1, wherein the pressurization core (210) comprises a vertical wall (212) with a front side and a back side, both sides connected through at least one passing hole (211), said front side comprising at least one nozzle (217) and said back side comprising at least one nozzle fitting (214) connected to said nozzle (217) through the passing hole (211), said fitting (214) for connecting the pressurization core (210) to the pneumatic system.

Embodiment A3. The device of embodiment 1 or 2, wherein the guiding platform comprises a holder with at least one compression spring disposed between the back side of the wall and said holder.

Embodiment A4. The device of any one of embodiments 1-3, wherein the blocking mechanism is disposed over the pressurization core and connected to the platform.

Embodiment A5. The device of any one of embodiments 1-4, wherein the blocking mechanism (300) comprises a cam follower (310).

Embodiment A6. The device of any one of embodiments 1-5, wherein the guiding platform (219) comprises lateral core guides (223) where lateral legs (224) in the pressurization core (210) are introduced for sliding within.

Embodiment A7. The device of any one of embodiments 1-6, further comprising a main electronic printed circuit board (PCB) (410) below the guiding platform (219).

Embodiment A8. The device of embodiment 7, wherein one side of the pressurization core (210) comprises two flanges (231, 232) reaching two sensors (400) connected to the main PCB (410) for determining the position of the core (210) with respect to the platform (219).

Embodiment A9. The device of any one of embodiments 1-8, wherein the device is integrated in a station (10), wherein the station comprises a body with the pneumatic system, an energy module, a display module, a casing for protecting all the components in the station (10), and a housing (11) with the pressurization core for receiving a biochip (100).

Embodiment A10. A biochip (100) comprising a body and at least a microfluidic channel, wherein the microfluidic channel comprises at least one pathway (110) on a surface of the body of the biochip (100), wherein the at least one pathway (110) comprises at least two curves (121, 122).

Embodiment A11. The biochip (100) of embodiment 10, wherein the at least one pathway (110) is on the top surface of the body of the biochip (100).

Embodiment A12. The biochip (100) of embodiment 10, wherein the at least one pathway is on a lateral surface of the body of the biochip (100).

Embodiment A13. The biochip (100) of any one of embodiments 10-12, further comprising:
at least one orifice (114) connected to at least one reservoir (106) inside the biochip (100), wherein the orifice (114) is at the base of a cavity (112) in the body of the biochip (100); and
a sealing gasket (108), wherein the sealing gasket is in the cavity (112), wherein the sealing gasket comprises at least one through hole aligned with the orifice (114) in the biochip (100).

Embodiment A14. The biochip of embodiment 13, further comprising a hydrophobic membrane (109) between the sealing gasket (108) and the orifice (114) connected to the reservoir (106); at least one through hole aligned with the though hole in the gasket and the orifice (14) in the biochip (100).

Embodiment A15. The biochip of any one of embodiments 10-14, wherein the biochip body further comprises:
an intermediate body with the at least one microchannel imprinted on the lower surface of the body and fluidically connected to an open well imprinted on the top surface of the body;
a lower body on the lower surface of the intermediate body to seal the imprinted microchannel; and
an upper body on the upper surface of the intermediate body with continuation walls of the well determining said open well and at least one reservoir connected to said well through at least said microchannel.

Embodiment A16. A coupling system comprising a biochip (100) of any one of embodiments 10-15 and a coupling device (210) of any one of embodiments 1-9, wherein:
the through hole in the sealing gasket faces a nozzle (217) on the front side of the wall (212) of the coupling device (210); and
the cam follower (310) of the blocking mechanism (300) of the coupling device (210) is introduced in the pathway (110) of the biochip (100) and determines at least two static positions between the biochip (100) and the coupling device (210) coinciding with the curves (121, 122) on the pathway (110).

Embodiment B1. A coupling device for coupling a biochip to a pneumatic system, the device comprising:
a) a pressurization core that is pneumatically connected to the pneumatic system, wherein the pressurization core is configured to receive the biochip and provide a pressurized seal between the biochip and the pneumatic system when the biochip is coupled to the pressurization core;
b) a blocking mechanism coupled to the pressurization core, wherein the blocking mechanism is configured to anchor the biochip to the pressurization core at a position suitable for providing the pressurized seal; and
c) a guiding platform coupled to the pressurization core, wherein the guiding platform is configured to guide the pressurization core and the biochip to slide along the guiding platform to a position at which the blocking mechanism anchors the biochip to the pressurization core.

Embodiment B2. The device of embodiment B1, wherein the pressurization core comprises a wall having a front side and a back side, wherein the wall comprises a through hole that traverses from the front side to the back side, wherein the front side comprises a nozzle and the back side comprises a nozzle fitting connected to the nozzle through the through hole, wherein the nozzle and the nozzle fitting join to connect the pressurization core to the pneumatic system.

Embodiment B3. The device of embodiment B1 or B2, wherein the guiding platform comprises a holder, wherein the holder is configured to anchor the pressurization core to the guiding platform.

Embodiment B4. The device of embodiment B3, wherein the holder comprises a compression spring, wherein the compression spring is located between the back side of the wall of the pressurization core and the holder, wherein the compression spring exerts a force between the biochip and the pneumatic system.

Embodiment B5. The device of any one of embodiments B1-B4, wherein the blocking mechanism is disposed over the pressurization core and connected to the guiding platform.

Embodiment B6. The device of any one of embodiments B1-B5, wherein the blocking mechanism comprises a cam follower, wherein the cam follower is configured to travel along a pathway on the biochip to anchor the biochip to the pressurization core.

Embodiment B7. The device of any one of embodiments B1-B6, wherein the guiding platform comprises a pair of lateral core guides, each of the lateral core guides disposed in parallel to one another on a top surface of the guiding platform, wherein each lateral core guide comprises a top surface and a bottom surface, wherein the bottom surface of each lateral core guide is layered onto the top surface of the guiding platform, wherein the top surface of each lateral core guide comprises an overhanging lip such that the top surface of each lateral core guide has a greater width than does the bottom surface of each lateral core guide, wherein the pair of lateral core guides is configured to anchor the pressurization core to the guiding platform, reduce a likelihood of rotation of the pressurization core, and guide alignment of the pressurization core and the guiding platform.

Embodiment B8. The device of embodiment B7, wherein the pressurization core comprises a pair of lateral legs, each lateral leg disposed in parallel to one another and configured such that when the pressurization core is disposed on the guiding platform, the pair of lateral legs is parallel to the pair of lateral core guides and each lateral leg fits under the overhanging lip of one of the lateral core guides.

Embodiment B9. The device of embodiment B7 or B8, further comprising a printed circuit board (PCB), wherein the PCB is disposed underneath the pressurization core, wherein a side of the pressurization core comprises two flanges, wherein the PCB comprises two sensors, wherein each of the two sensors is configured to detect one of the flanges of the pressurization core when the pressurization core is disposed on the guiding platform at a position to form the pressurized seal between the biochip and the pneumatic system.

Embodiment B10. The device of any one of embodiments B1-B9, wherein the device is configured to be integrated with a station that comprises the pneumatic system.

Embodiment B11. A system, the system comprising:
a) the device of any one of embodiments B1-B10; and
b) a station, wherein the station is configured to receive the device.

Embodiment B12. The system of embodiment B11, wherein the station further comprises an energy module, wherein the energy module supplies power to the system.

Embodiment B13. The system of embodiment B11 or B12, wherein the station further comprises a display module, wherein the display module provides a user interface for controlling the system.

Embodiment B14. The system of any one of embodiments B11-B13, wherein the station further comprises a casing, wherein the casing encases components of the station.

Embodiment B15. The system of any one of embodiments B11-B14, wherein the station further comprises a housing, wherein the housing houses the pressurization core.

Embodiment B16. A biochip, the biochip comprising:
a) a body comprising a surface;
b) a microfluidic channel,
c) a pathway on the surface of the body, wherein the pathway comprises at least two curves;
d) an orifice connected to a reservoir that is fluidically connected to the microfluidic channel, wherein the orifice is at a base of a cavity in the body of the biochip; and
e) a sealing gasket, wherein the sealing gasket is located in the cavity of the body of the biochip, wherein the sealing gasket comprises a through hole configured to be aligned with the orifice in the biochip.

Embodiment B17. The biochip of embodiment B16, wherein the pathway is on a top surface of the body of the biochip.

Embodiment B18. The biochip of embodiment B16, wherein the pathway is on a lateral surface of the body of the biochip.

Embodiment B19. The biochip of any one of embodiments B16-B18, further comprising a hydrophobic membrane between the sealing gasket and the orifice, wherein the hydrophobic membrane comprises a through hole configured to be aligned with the through hole in the sealing gasket and the orifice in the biochip.

Embodiment B20. The biochip of any one of embodiments B16-B19, further comprising an intermediate body, wherein the intermediate body comprises the microchannel imprinted on a lower surface of the body, wherein the intermediate body is fluidically connected to a well imprinted on the top surface of the body.

Embodiment B21. The biochip of embodiment B20, further comprising a lower body disposed on the lower surface of the intermediate body to seal the imprinted microchannel.

Embodiment B22. The biochip of embodiment B21, further comprising an upper body disposed on the upper surface of the intermediate body, wherein the upper body comprises the walls of the well and the reservoir that is fluidically connected to the well through the microchannel.

Embodiment B23. A coupling system, the coupling system comprising:
a) a biochip, wherein the biochip comprises:
   i) a body comprising a surface;
   ii) a microfluidic channel,
   iii) a pathway on the surface of the body, wherein the pathway comprises at least two curves;
   iv) an orifice connected to a reservoir that is fluidically connected to the microfluidic channel, wherein the orifice is at a base of a cavity in the body of the biochip; and
   v) a sealing gasket, wherein the sealing gasket is located in the cavity, wherein the sealing gasket comprises a through hole configured to be aligned with the orifice in the biochip;
b) a pneumatic system configured to deliver pressurized air to the biochip; and
c) a coupling device for coupling the biochip to the pneumatic system, wherein the coupling device comprises:
   i) a pressurization core that is pneumatically connected to the pneumatic system, wherein the pressurization core is configured to receive the biochip and provide a pressurized seal between the biochip and the pneumatic system when the biochip is coupled to the pressurization core;
   ii) a blocking mechanism coupled to the pressurization core, wherein the blocking mechanism is configured to anchor the biochip to the pressurization core at a position suitable for providing the pressurized seal; and
   iii) a guiding platform coupled to the pressurization core, wherein the guiding platform is configured to guide the pressurization core and the biochip to slide along the guiding platform to a position at which the blocking mechanism anchors the biochip to the pressurization core.

Embodiment B24. The coupling system of embodiment B23, wherein:
the biochip further comprises a sealing gasket, wherein the sealing gasket is disposed in the cavity of the body of the biochip, wherein the sealing gasket comprises a through hole configured to be aligned with the orifice in the biochip;
the pressurization core of the coupling device comprises a wall having a front side and a back side, wherein the wall comprises a through hole that traverses from the front side to the back side, wherein the front side comprises a nozzle and the back side comprises a nozzle fitting connected to the nozzle through the through hole, wherein the nozzle and the nozzle fitting join to connect the pressurization core to the pneumatic system;
the blocking mechanism of the coupling device comprises a cam follower, wherein the cam follower, wherein the cam follower is configured to travel along a pathway on the biochip to anchor the biochip to the pressurization core, wherein:
   the through hole in the sealing gasket couples to the nozzle on the front side of the wall of the coupling device, and
   the cam follower of the blocking mechanism of the coupling device is introduced in the pathway of the biochip, wherein the pathway determines two static positions between the biochip and the coupling device during coupling, wherein the two static positions coincide with the at least two curves of the pathway.

1. A coupling device (200) for coupling and de-coupling a biochip (100) to a pneumatic system, the device comprising:
a) a sliding pressurization core (210) that is pneumatically connected to the pneumatic system, wherein the pressurization core (210) is configured to receive the biochip (100) and provide a pressurized seal between the biochip (100) and the pneumatic system when the biochip (100) is coupled to the pressurization core;
b) a blocking mechanism (300) coupled to the pressurization core (210), wherein the blocking mechanism (300) is configured to anchor the biochip (100) to the pressurization core (210) at a position suitable for providing the pressurized seal, comprising a push-push mechanism that allows anchoring of the biochip (100) to the pressurization core (200) during coupling of the biochip (100), and removal of the biochip (100) from the pressurization core (200) during de-coupling of the biochip (100), and
c) a guiding platform (219) configured to guide the sliding pressurization core (210), wherein the guiding platform (219) is configured to guide the pressurization core (219) and the biochip (100) along the guiding platform (219) to a position at which the blocking mechanism (300) anchors the biochip (100) to the pressurization core (210).

2. The device of claim 1, wherein the pressurization core comprises a wall having a front side and a back side, wherein the wall comprises a through hole that traverses from the front side to the back side, wherein the front side comprises a nozzle and the back side comprises a nozzle fitting connected to the nozzle through the through hole, wherein the nozzle and the nozzle fitting join to connect the pressurization core to the pneumatic system.

3. The device of claim 1, wherein the guiding platform comprises a holder, wherein the holder is configured to anchor the pressurization core to the guiding platform.

4. The device of claim 3, wherein the holder comprises a compression spring, wherein the compression spring is located between the back side of the wall of the pressurization core and the holder, wherein the compression spring exerts a force between the biochip and the pneumatic system.

5. The device of claim 1, wherein the blocking mechanism is disposed over the pressurization core and connected to the guiding platform.

6. The device of claim 1, wherein the blocking mechanism comprises a cam follower, wherein the cam follower is configured to travel along a pathway on the biochip to anchor the biochip to the pressurization core.

7. The device of claim 1, wherein the guiding platform comprises a pair of lateral core guides, each of the lateral core guides disposed in parallel to one another on a top surface of the guiding platform, wherein each lateral core guide comprises a top surface and a bottom surface, wherein the bottom surface of each lateral core guide is layered onto the top surface of the guiding platform, wherein the top surface of each lateral core guide comprises an overhanging lip such that the top surface of each lateral core guide has a greater width than does the bottom surface of each lateral core guide, wherein the pair of lateral core guides is configured to anchor the pressurization core to the guiding platform, reduce a likelihood of rotation of the pressurization core, and guide alignment of the pressurization core and the guiding platform.

8. The device of claim 7, wherein the pressurization core comprises a pair of lateral legs, each lateral leg disposed in parallel to one another and configured such that when the pressurization core is disposed on the guiding platform, the pair of lateral legs is parallel to the pair of lateral core guides and each lateral leg fits under the overhanging lip of one of the lateral core guides.

9. The device of claim 7, further comprising a printed circuit board (PCB), wherein the PCB is disposed underneath the pressurization core, wherein a side of the pressurization core comprises two flanges, wherein the PCB comprises two sensors, wherein each of the two sensors is configured to detect one of the flanges of the pressurization core when the pressurization core is disposed on the guiding platform at a position to form the pressurized seal between the biochip and the pneumatic system.

10. The device of claim 1, wherein the device is configured to be integrated with a station that comprises the pneumatic system.

11. A system, the system comprising:
a) the device of claim 1; and
b) a station, wherein the station is configured to receive the device.

12. The system of claim 11, wherein the station further comprises an energy module, wherein the energy module supplies power to the system.

13. The system of claim 11, wherein the station further comprises a display module, wherein the display module provides a user interface for controlling the system.

14. The system of claim 11, wherein the station further comprises a casing, wherein the casing encases components of the station.

15. The system of claim 11, wherein the station further comprises a housing, wherein the housing houses the pressurization core.

16. A biochip, the biochip comprising:
a) a body comprising a surface;
b) a microfluidic channel,
c) a pathway on the surface of the body, wherein the pathway comprises at least two curves;
d) an orifice connected to a reservoir that is fluidically connected to the microfluidic channel, wherein the orifice is at a base of a cavity in the body of the biochip; and
e) a sealing gasket, wherein the sealing gasket is located in the cavity of the body of the biochip, wherein the sealing gasket comprises a through hole configured to be aligned with the orifice in the biochip.

17. The biochip of claim 16, wherein the pathway is on a top surface of the body of the biochip.

18. The biochip of claim 16, wherein the pathway is on a lateral surface of the body of the biochip.

19. The biochip of claim 16, further comprising a hydrophobic membrane between the sealing gasket and the orifice, wherein the hydrophobic membrane comprises a through hole configures to be aligned with the through hole in the sealing gasket and the orifice in the biochip.

20. The biochip of claim 16, further comprising an intermediate body, wherein the intermediate body comprises the microchannel imprinted on a lower surface of the body, wherein the intermediate body is fluidically connected to a well imprinted on the top surface of the body.

21. The biochip of claim 20, further comprising a lower body disposed on the lower surface of the intermediate body to seal the imprinted microchannel.

22. The biochip of claim 21, further comprising an upper body disposed on the upper surface of the intermediate body, wherein the upper body comprises the walls of the well and the reservoir that is fluidically connected to the well through the microchannel.

23. A coupling system, the coupling system comprising:
a) a biochip comprising:
i) a body comprising a surface,
ii) a microfluidic channel,
iii) a pathway on the surface of the body, wherein the pathway comprises at least two curves,
iv) an orifice connected to a reservoir that is fluidically connected to the microfluidic channel, wherein the orifice is at a base of a cavity in the body of the biochip; and
v) a sealing gasket, wherein the sealing gasket is located in the cavity of the body of the biochip, wherein the sealing gasket comprises a through hole configured to be aligned with the orifice in the biochip;
b) a pneumatic system configured to deliver pressurized air to the biochip; and
c) a coupling device for coupling the biochip to the pneumatic system according to claim 1.

24. The coupling system of claim 23, wherein:
the pressurization core of the coupling device comprises a wall having a front side and a back side, wherein the wall comprises a through hole that traverses from the front side to the back side, wherein the front side comprises a nozzle and the back side comprises a nozzle fitting connected to the nozzle through the through hole, wherein the nozzle and the nozzle fitting join to connect the pressurization core to the pneumatic system;
the blocking mechanism of the coupling device comprises a cam follower, wherein the cam follower, wherein the cam follower is configured to travel along a pathway on the biochip to anchor the biochip to the pressurization core, wherein:
the through hole in the sealing gasket couples to the nozzle on the front side of the wall of the coupling device, and
the cam follower of the blocking mechanism of the coupling device is introduced in the pathway of the biochip, wherein the pathway determines two static positions between the biochip and the coupling device during coupling, wherein the two static positions coincide with the at least two curves of the pathway.
